(19) United States
(12) Patent Application Publication
(10) Pub. No.: US 2003/0188443 A1
(43) Pub. Date: Oct. 9, 2003

(54) Shearing snuff can opener

(76) Inventors: Kevin Imer, Gallipolis, OH (US); Cornell Drajan JR., Hendersonville, NC (US)

Correspondence Address: WINSTON & STRAWN, PATENT DEPARTMENT, 1400 L STREET, N.W., WASHINGTON, DC, 20005-3502, US

(21) Appl. No.: 10/147,311

(22) Filed: May 17, 2002

Related U.S. Application Data
(63) Continuation-in-part of application No. 10/118,031, filed on Apr. 9, 2002.

(51) Int. Cl. B67B 7/46

(52) U.S. Cl. 30/400

(57) ABSTRACT

A can opener that has a circumferential support member that is manipulable by a user for axial rotation about a can. The circumferential support member has generally curved inner surface generally corresponding to the shape of the can. A cutting blade is mounted to the circumferential support member and includes a shearing portion configured for shearing at least a shearable portion of a can wall of the can against an opposing portion of the can that faces substantially axially, upon the axial rotation of the circumferential support member about the can.

### CROSS-REFERENCE TO RELATED APPLICATION

The present application is a continuation-in-part of U.S. application Ser. No. 10/118,031, filed on Apr. 9, 2002, the content of which is hereby expressly incorporated herein by reference thereto.

### FIELD OF THE INVENTION

The present invention relates to a can opener. More particularly, the invention relates to a hand held and operated can opener that can shear a least a portion of a can wall against another part of the can.

### BACKGROUND OF THE INVENTION

Traditional snuff cans have a plastic or cardboard cylindrical wall and bottom wall, and a metal or plastic lid. A lip of the lid extends parallel to and against the cylindrical wall and is sealed, such as by a wax coating in the interior and top edges of the cylindrical and bottom walls. A paper label is wrapped and adhered around the lid lip and the cylindrical wall to keep the can closed. To open the can, a user needs to peel away the paper label and lift or pry, and typically twist, the lid off the can. This is often accomplished using one's nails and teeth.

A snuff can opener is known with a flat portion that has a pie-slice shape, and with a semicylindrical portion holding sharply angled small serrations to cut the paper label. The serrations usually get caught in the paper and tear it roughly, making it difficult to cut the paper and severing the paper unevenly. The uneven tearing is not only unsightly, but also makes the lid hard to detach and does not produce evenly repeatable results.

A can opener is needed that can smoothly and repeatably open or assist in opening a can, such as a snuff can.

### SUMMARY OF THE INVENTION

The present invention relates to a can opener that is configured for enabling a user to open a can, such as a snuff tobacco can. A preferred embodiment of the invention comprises a circumferential support member that is manipulable by a user for axial rotation about a can. The circumferential support member has a generally curved inner surface generally corresponding to the shape of the can. A cutting blade is mounted to the circumferential support member and has a shearing portion configured for shearing at least a shearable portion of a can wall of the can against an opposing portion of the can that faces substantially axially when the circumferential support member is rotated axially about the can. The opposing portion is preferably part of the can lid.

In this embodiment, the shearing portion of the blade includes a leading edge that separates first and second blade surfaces. The leading edge is disposed on a circumferential side of the blade and is configured for shearing the shearable portion against the opposing portion of the can upon the axial rotation. The first blade surface extends from an axial side of the leading edge and is disposed for facing the opposing can portion during the rotation. The first blade surface is preferably substantially flat and preferably extends along a substantially radial plane. The second blade surface extends from an opposite axial side of the leading edge from the first blade surface.

The preferred second blade surface extends from the leading edge at an angle of at least about 80° to a radial plane. Preferably, there are a plurality of blades in the can opener, with the blades being displaced circumferentially with respect to each other with the leading edges disposed substantially equally with respect to a common plane. The second blade surface in this embodiment extends from the leading edge at an angle of at least about 80° to the common plane.

Also, the leading edge is preferably oriented at an angle to an axial plane extending through the radius of the can wall and through the leading edge, where the angle is sufficient for directing the shearable portion of the wall to a shearing zone between the blade and said opposing portion of the can. The leading edge is preferably oriented at an average angle of more than about 10° to this axial plane. The leading edge can be curved or straight when viewed axially, and is preferably convex.

In an embodiment that has a plurality of blades, the first blade surfaces are disposed substantially in a common radial plane. One of the blades is preferably disposed at a circumferential end of the circumferential support member, and the shearing portions comprise leading edges disposed on a circumferential ends thereof facing in the direction of said rotation. Preferably, leading edges that face in a same circumferential direction of adjacent blades are disposed at least about 50° from each other. A circumferential space of at least about 3° about the axis of the can is preferably defined between adjacent blades. Each blade preferably extends circumferentially over at least about a 5° angle.

Preferably, the circumferential support member comprises an arcuate inner surface substantially corresponding to the shape of the can and has an outer surface textured for high traction against the user's hand in the direction of the rotation. The circumferential support member preferably extends circumferentially by about between 45° and 180°.

A top support member is attached to the circumferential support member with respect to the blade for positioning the blade adjacent the opposing portion of the can in the preferred embodiment. This top support member has a generally flat surface facing substantially axially towards the blade and disposed in relation with the blade for positioning the blade at a distance of about between 0.15 and 0.5 inches from an end of the can during the shearing. An attachment member can be connected to one or both support members, defining an opening sized to attach to a key ring.

It is preferred that just an outer sheet of the wall of the can be sheared upon the rotation of the can opener. The blade is thus preferably disposed, dimensioned, and configured for cutting the outer sheet and not cutting all the way through another layer of the wall.

The present invention thus provides a hand held can opener that can easily be carried in a user's pocket and that can smoothly cut a portion of a can wall, such as the paper label that closes and provides a measure of sealing in a snuff can, or other type of can.

### BRIEF DESCRIPTION OF THE DRAWINGS

FIG. 1 is a bottom perspective view of an embodiment of a can opener constructed according to the present invention;

FIG. 2 is a side cut-away view thereof with a cross-sectional portion taken along plane II-II of FIG. 1, showing the can opener in the process of opening a can;

FIG. 3 is a top perspective view of the can opener, showing an optional attachment member;

FIG. 4 is a top perspective view thereof in the process of opening a can;

FIG. 5 is a bottom perspective view of another embodiment of the invention; and

FIG. 6 is bottom perspective view thereof in the process of opening a can.

### DETAILED DESCRIPTION OF THE PREFERRED EMBODIMENTS

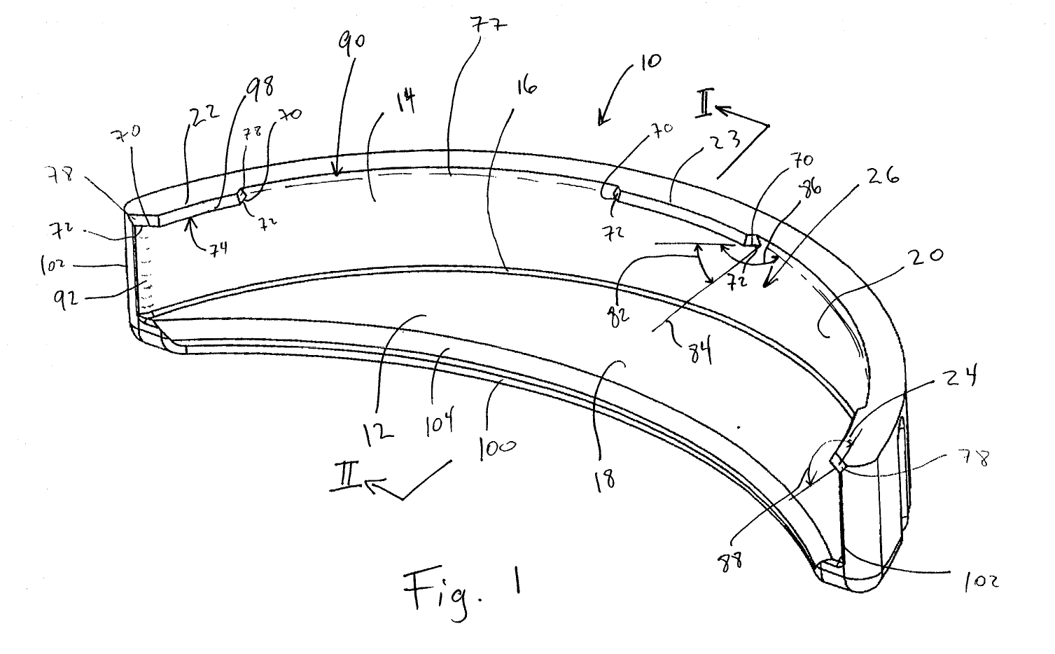

Referring to FIG. 1, a preferred embodiment of the invention is a can opener 10 with top and circumferential support members 12,14. The preferred can opener 10 has no moving parts, although moving parts can be provided in alternative embodiments, and is manufactured as an integral piece. The top and circumferential support members 12,14 of the embodiment shown are attached to each other at edge 16, defining a can-receiving space 26 therebetween. Top and circumferential support members 12,14 are preferably of unitary construction.

Top inner surface 18 of the top support member 12 preferably extends at an angle to circumferential inner surface 20 of the circumferential support member 14, facing a can receiving space 26. The circumferential inner surface 20 preferably has an arcuate shape that substantially corresponds to the shape of the can. In an embodiment for opening a snuff can, the circumferential inner surface 20 is preferably semicircular, extending along less than half of a circle to facilitate placement against the side of the can, and has a radius of between about 1.3 and 1.4 inches, and most preferably around 1.34 inches. The preferred radius is substantially the same or slightly larger than that of the can intended to be opened. Other embodiments have radii of the circumferential inner surface 20 of about between 1 and 3 inches. The size of the can opener 10 is preferably selected for holding and operating with a single hand, possibly with the other hand holding the can.

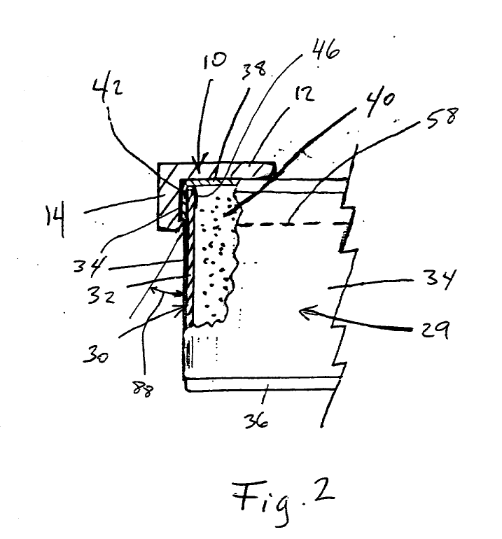

As shown in FIG. 2, a preferred can 29 includes a can wall 30, which can include several layers. Can wall 30 includes an inner, structural wall member 32, and an outer portion, such as a thin label 34 made sheet of paper, plastic, or metal. The can also has a bottom wall 36, which is preferably attached to the structural wall member 32 and may have a shoulder wrapped vertically therearound. A closure, such as a lid 38 is preferably associated with the wall 30 to close and seal the can and its contents 40. The contents 40 can comprise snuff, other forms of smokeless or other tobaccos, foods such as beef jerky, or other products. The lid 38 has an lip portion 42 fitted over the structural wall member 32 and beneath the label 34, thus forming a portion of the wall 30 disposed between the structural wall member 32 and the label 34. The can lip 42 includes an axial end surface 58, preferably at an axial edge of the lip 42. An adhesive preferably attaches the label 34 to the lid 38 and structural wall member 32, and a wax 46 preferably seals the space therebetween. The lid 38 is preferably made of a metal, such as tin, a paper, such as a cardboard, or a plastic, but may alternatively be made of other materials. The structural wall member 32 is preferably made of a rolled cardboard tube, but may alternatively be made of other materials, including a metal or a plastic and can be formed unitarily with the bottom wall 30.

Referring to FIGS. 1 and 2, cutting blades 22-24 extend radially inwardly toward the can-receiving space 26 and are mounted to the circumferential support member 14. Each blade 22-24 preferably has a shearing portion 70 which preferably includes a leading edge 72 on each circumferential side thereof. The leading edges are preferably sharp, but other configurations suitable for shearing the portion of the can wall 30 can alternatively be employed. The shearing portions 70 and leading edges 72 are configured and disposed on the circumferential support member 14 for shearing at least a portion of a can wall 30, such as the label 34, against an opposing surface of an opposing portion of the can 29, such as the axial end surface 58 of the lip 42, when the can opener 10 is rotated circumferentially about and against the can 29. Preferably, the shearing portion 70 has a first blade surface 74 extending from the leading edge 72 disposed for facing and abutting the axial end surface 58 of can 29, with the shearing portion 70 in shearing association with the axial end 58 for shearing the label 34 or more layers of the can wall 30. In an alternative embodiment, the blades are positioned and configured for scoring or cutting the label 34 and other layers of the wall 30, and in one embodiment, the blades cut through a portion or all of a structural wall member of a can wall 30.

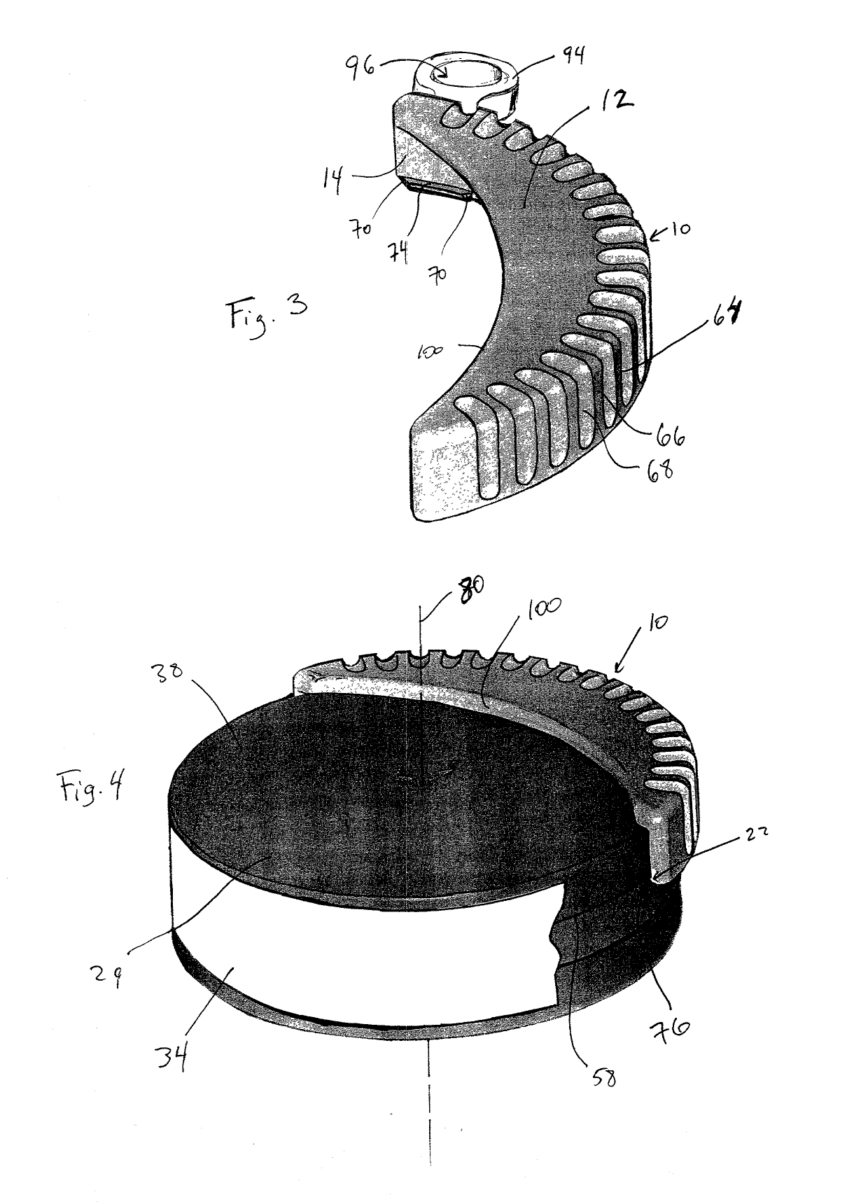

The first surface 74 is preferably substantially flat, and is also preferably disposed substantially in a radial plane transverse to the axis of the can 29 and of the can opener 10. In the preferred embodiment, the first surface 74 is configured to glide against the axial end surface 58 of the lip 42, preferably over most or all of the circumferential length of the first surface 74. The first surface 74 is disposed with respect to the leading edge 72 and configured to obtain a clean shearing zone 76 between the blades 22-24 and the can axial end surface 58, as shown in FIG. 4, preferably with the leading edge 72 abutting the axial end surface 58, and more preferably also with the first surface 74 abutting the axial end surface 58. In FIG. 4, the label 34 is partially cut away to show the can structure, and the lid 38, which if received between the top support ember and blades 22-24. In an alternative embodiment, the first surface 74 slopes away from the axial end surface 58 and the radial plane in which it is located. In the preferred embodiment, the shearing portion 70 and preferably also the first surface 74 are disposed at an angle of less than about 5° to the radial plane that extends through the rounded and preferably circular phantom shape 77 on which the blades 22-24 are disposed and rounded shape 77 of the preferred inner surface 20 of the circumferential support member 14.

As it is preferred that the can opener 10 be able to function when rotated in either direction about the axis 80 of the can 29 and can opener 10, shown in FIG. 4, a leading edge 72 is disposed on both circumferential sides of the blades 22-24. The leading edge 72 in the embodiment shown is substantially straight. The leading edge 72 is preferably angled inwardly towards the remainder of the blade with respect to the radius 84 of the can 29 and can opener 10 by an angle 82 taken along the radial plane of rounded shape 77, with an angle 86 of more than 90° to the rounded shape 77. Angle 82 is preferably between about 0° and 45°, is more than about 10° to the extension of the radius 84 along an axial plane that passes through the leading edge 72. In an alternative embodiment, angle 86 is less than 90°. Also, alternative embodiments may have concave or convex leading edges that are curved.

A second blade surface 78 disposed on an opposite axial side of the blades 22-24 from the first blade surface 74 is preferably extends from the leading edge 72 at an angle 88 at least about 80° to the radial plane of the rounded shape 77, which is the plane along which the blades 22-24 travel during the rotation about the can 29 and which is the common plane with respect to which the blades 22-24 are substantially equally positioned in the preferred embodiment. Angles 88 and 82 are preferably selected to direct and feed the label 34 into the shearing zone 76.

The blades 22-24 of the preferred embodiment are displaced circumferentially with respect to each other. A circumferential space 90 is defined between adjacent ones of the blades 22-24 of at least about 3°, more preferably at least about 10°, and most preferably more than about 30° and less than about 170° about the axis 80. Each blade 22-24 preferably extends circumferentially over at least about a 5° angle. One or two of the blades 22,24 can be disposed at a circumferential end of the circumferential support member 14, preferably with a third blade 23 centered therebetween. Preferably, the leading edges 72 of adjacent blades that face in a same circumferential direction are displaced from each other about the axis 80 by an angle of at least about 5°, more preferably at least about 15°, and most preferably be at least about 30° and less than about 180°.

The radially inner surfaces 98 of the blades 22-24 are preferably disposed on a common rounded shape, which is preferably circular and which is of a smaller diameter than then inner circumferential surface 20. The rounded shape and position of the inner blade surfaces 98 is preferably configured to correspond to and follow the shape of a portion of the can 29 disposed adjacent and radially inward from the axial end 58 of the lid 38. The inner blade surfaces 98 can be configured for providing radial support to the can opener 10 against the can 29 during use. The blades 22-24, and the inner surfaces 98 are preferably oriented substantially parallel with the axis of rotation during cutting, and are preferably parallel to the top inner surface 18, but can be in different orientations that are suitable for shearing the label 34.

The circumferential support member 14 itself preferably extends circumferentially by about between 45° and 180°, as does top support member 12. The circumferential ends 92 of the circumferential support member 14 are preferably angled away outwardly from the inner circumferential surface 20 and are preferably rounded to prevent their catching against the can 29 or the label 34 as the can opener 10 is rotated thereabout and to permit the rotation to be smooth. The top inner surface 18 also has an edge surface 104 leading to edge 100, which is angled away from the can receiving space 26 and which is preferably rounded, curving away from the top inner surface 18 to facilitate placing of the can opener 10 on a can 29.

The top support member 12 preferably is attached to the circumferential support member 14 and with respect to the blades 22-24 for positioning the blades 22-24 adjacent the axial end surface 58 the can 29. The top inner surface 18 is configured for contacting the top of the can 29 and is preferably generally flat and faces axially towards the blades 22-24 and the can receiving space 26. The top inner surface 18 is configured and disposed in relation with the blade 22-24 for positioning them at a distance of about between 0.15 and 0.5 inches from an end of the can during the cutting, which is preferably selected to position the blades 22-24 in shearing association with the lid 38, or near a position where the shearing can take place. Both the top and circumferential support members 12,15 are preferably configured for guiding and the blades 22-24 along the circumferential can wall 30 in the shearing position for shearing the label 34.

Referring to FIGS. 3 and 4, the can opener 10 includes a high traction, textured outer surface 64 on the outside of the circumferential support member 14, configured to improve the gripping traction against a user's hand to facilitate operation of the can opener. The textured surface 64 of the embodiment shown includes a plurality of generally vertical ribs 66 spaced by grooves 68 extending substantially across the height of the circumferential support member 14 and onto the top support member 12. The ribs can have other orientations, but preferably cross the direction of rotation and are preferably not parallel thereto. Other textured surfaces include a roughened or gritty texture, although other embodiments can have a smooth and even outer surface.

A key ring attachment 94 is optionally provided in the embodiment in FIG. 3. The key ring attachment 94 is preferably located adjacent or at an end of the circumferential support member 14, although other locations can be suitable. An opening 96 is defined in the key ring attachment 94, configured and dimensioned to receive and attach to a key ring or key chain. The opening 96 is preferably smaller than about 0.3 inches.

To operate the can opener 10, a user can hold that opener 10 with one or more fingers and, if desired, with a portion of the palm placed about the outside of the circumferential support member 14, with the top support member 12 placed against the lid 38. The preferred location for the blades 22-24 to cut the wall 30 is adjacent and against bottom axial edge 58 of the lid lip 42. The relation between the position of the blades 22-24 and the top support member 12 is selected to position the blades 22-24 at a predetermined distance below the top of the can 29. This distance is preferably about between 0.15 and 0.5 inches, and for a snuff can is preferably about between 0.25 inches and 0.35 inches, most preferably about 0.29 inches to the blade edge 28.

The blades 22-24 are preferably made of a plastic, and are preferably of unitary construction with the rest of the can opener portions. A most preferred material for the can opener is high density polystyrene. The blades 22-24 can alternatively be made of a metal or other suitable material for cutting. Preferably, the blades comprise an abrasive material for improving the cutting of the label 34 or other desired wall portion. One preferred embodiment of the blades is made of a plastic with exposed diamond dust, preferably coated thereon, to improve cutting efficiency and durability.

The preferred embodiment is sized to fit into a user's clothing pocket, and to save space, the top support member 12 has an edge 100 opposite from the circumferential support member 14 that extends between the lateral ends 60 of the circumferential support member 14 and is curved and concave. The edge 100 may alternatively be straight or have a curvature or bends that preferably do not greatly increase the width of the can opener. The can opener preferably has a long dimension in the direction between circumferential ends 102 of the can opener 10 that is preferably less than about 4 inches and more preferably less than about 3 inches. The width in a direction generally orthogonal to the longest dimension is preferably less than about 2 inches, and more preferably less than about an inch.

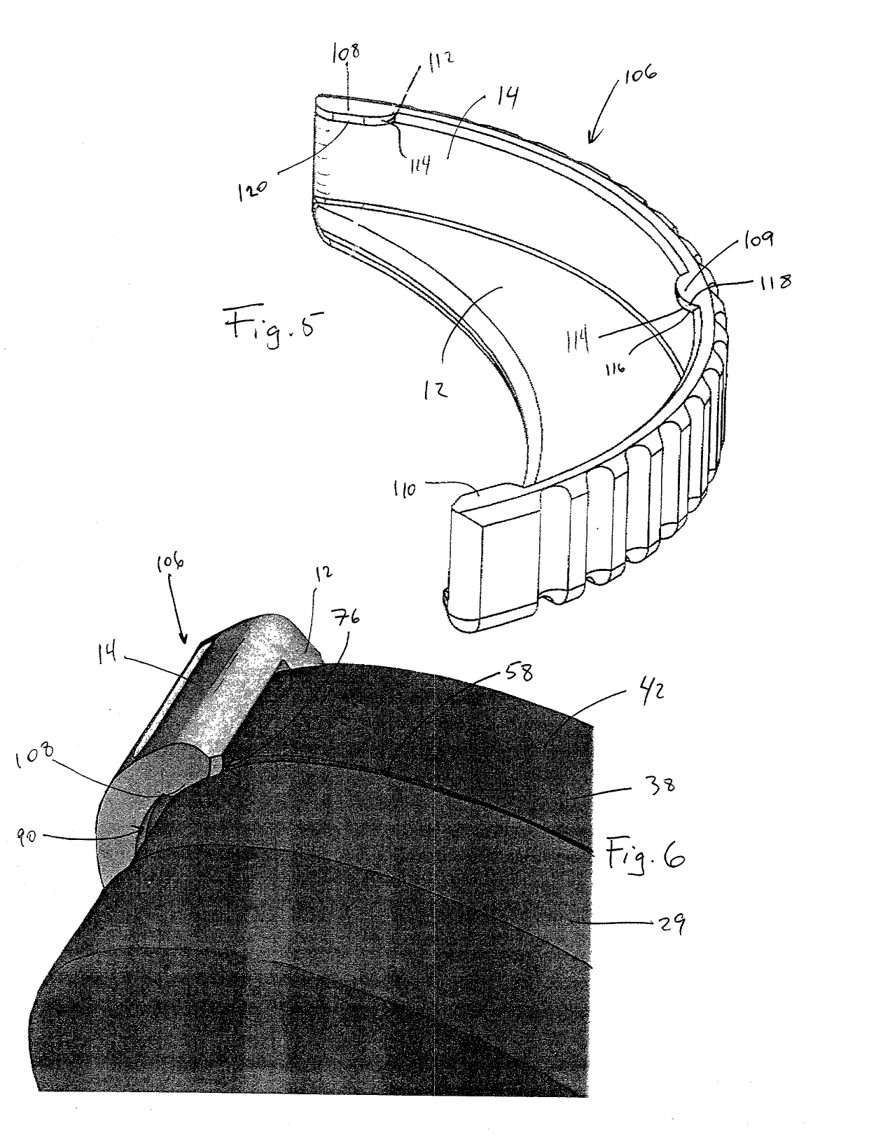

Referring to FIGS. 5 and 6, another embodiment of a can opener 106 has blades 108-110 with shearing portions 112 with second blade surfaces 114 which are tapered in the circumferential or rotational direction. The blades 108-110 have a sharp leading edge 116 positioned to shearingly abut the can lip 42 and a trailing edge or portion 118 disposed across the second blade surface 114 and circumferentially behind the leading edge 116 in the rotational direction of the can opener 106. Viewed along the axis of the can opener 106, the blades 108-110 have rounded contours on the circumferential sides thereof to smoothly feed the portion of the can wall 30 to be cut into the shearing zone, as the leading edges 116 curve inwardly and rearwardly with respect to the direction of rotation for the respective leading edge 166 to shear the label 34. Other leading edge shapes can be used. The preferred shapes are convex.

The inner surfaces 120 of this embodiment are substantially aligned with the axis of the can opener 106. In FIG. 6, blade 108 can be seen in a shearing position against the axial edge 58 of the lid 38, and the label 34 is shown in phantom lines for convenience of illustration.

While illustrative embodiments of the invention are disclosed herein, it will be appreciated that numerous modifications and other embodiments may be devised by those skilled in the art. For example, the top and circumferential support members may have shapes such that they contact the can at a plurality of points instead of substantially equally along their extent. Therefore, it will be understood that the appended claims are intended to cover all such modifications and embodiments that come within the spirit and scope of the present invention.

What is claimed is:

1. A can opener, comprising:
a circumferential support member that is manipulable by a user for axial rotation about a can; and
a cutting blade mounted to the circumferential support member and comprising a shearing portion configured for shearing at least a shearable portion of a can wall of the can against an opposing portion of the can that faces substantially axially, upon the axial rotation of the circumferential support member about the can.

2. The can opener of claim 1, wherein the shearing portion comprises:
a leading edge on a circumferential side thereof configured for shearing the shearable portion against opposing portion of the can upon the axial rotation;
a first blade surface extending from one axial side of the leading edge disposed for facing the opposing portion during the rotation, wherein the first blade surface is substantially flat; and
a second blade surface extending from an opposite axial side of the leading edge from the first blade surface.

3. The can opener of claim 2, wherein the first blade surface extends along a substantially radial plane.

4. The can opener of claim 1, wherein:
the blade comprises a plurality of blades displaced circumferentially with respect to each other; and
a circumferential space is defined between adjacent ones of the blades of at least about 3° about the axis of the can.

5. The can opener of claim 1, wherein:
the shearing portion comprises a leading edge disposed on a circumferential side thereof facing in the direction of said rotation, the leading edge being convex when viewed axially and is configured and oriented for smoothly cutting the portion of the can.

6. The can opener of claim 1, wherein the circumferential support member comprises an arcuate inner surface substantially corresponding to the shape of the can.

7. The can opener of claim 1, wherein the circumferential support member comprises an outer surface textured for high traction against the user's hand in the direction of the rotation.

8. The can opener of claim 1, wherein the circumferential support member extends circumferentially by about between 45° and 180°.

9. The can opener of claim 1, further comprising a top support member attached to the circumferential support member with respect to the blade for positioning the blade adjacent the opposing portion of the can.

10. The can opener of claim 9, wherein the top support member has a generally flat surface facing substantially axially towards the blade and disposed in relation with the blade for positioning the blade at a distance of about between 0.15 and 0.5 inches from an end of the can during the shearing.

11. The can opener of claim 1, further comprising an attachment member connected to the support members and defining an opening sized to attach to a key ring.

12. The can opener of claim 1, wherein:
the shearable portion is an outer sheet; and
the blade is disposed, dimensioned, and configured for cutting the outer sheet and not cutting all the way through another layer of the wall.

13. The can opener of claim 1, wherein the blade extends circumferentially over at least about a 5° angle.

14. The can opener of claim 1, wherein said opposing portion of the can is a can lid.

15. The can opener of claim 1, wherein the circumferential support member has a curved inner surface generally corresponding to the shape of the can.

16. A can opener, comprising:
a circumferential support member that is manipulable by a user for axial rotation about a can; and
a plurality of cutting blades mounted to the circumferential support member displaced circumferentially with respect to each other, each blade comprising a shearing portion configured for shearing at least a shearable portion of a can wall of the can against an opposing portion of the can that faces substantially axially, upon the axial rotation of the circumferential support member about the can.

17. The can opener of claim 16, wherein the blades comprise substantially flat first surfaces disposed for facing and abutting the opposing portion of the can for shearing said portion of the can wall.

18. The can opener of claim 17, wherein the first surfaces are disposed substantially in a common radial plane.

19. The can opener of claim 17, wherein one of the blades is disposed at a circumferential end of the circumferential support member.

20. The can opener of claim 17, wherein:
the shearing portions comprise leading edges disposed on a circumferential ends thereof facing in the direction of said rotation; and
adjacent ones of the leading edges are disposed at least about 5° from each other.

21. A can opener, comprising:
a circumferential support member that is manipulable by a user for axial rotation about a can; and
a cutting blade mounted to the circumferential support member and comprising a shearing portion comprising:
a leading edge on a circumferential side thereof configured for shearing at least a shearable portion of a can wall of the can against opposing portion of the can that faces substantially axially, upon the axial rotation of the circumferential support member about the can,
a first blade surface extending from one axial side of the leading edge disposed for facing the opposing portion during the rotation, and
a second blade surface extending from an opposite axial side of the leading edge from the first opener edge.

22. The can opener of claim 21, wherein the second blade surface extends from the leading edge at an angle of at least about 80° to a radial plane.

23. The can opener of claim 21, wherein:
the blade comprises a plurality of blades displaced circumferentially with respect to each other with the leading edges disposed substantially equally with respect to a common plane; and
the second blade surface extends from the leading edge at an angle of at least about 80° to the common plane.

24. The can opener of claim 21, wherein the leading edge is oriented at an angle to an axial plane extending through the radius of the can wall and through the leading edge, said angle being sufficient for directing the shearable portion of the wall to a shearing zone between the blade and said opposing portion of the can.

25. The can opener of claim 24, wherein the leading edge is oriented at an average angle of more than about 10° to said axial plane.

26. The can opener of claim 24, wherein the leading is curved when viewed axially.
